(19) United States
(12) Patent Application Publication
(10) Pub. No.: US 2024/0403085 A1
(43) Pub. Date: Dec. 5, 2024

(54) TECHNIQUES FOR PROVIDING FOCUS

(71) Applicant: Apple Inc., Cupertino, CA (US)

(72) Inventors: Filipp ZAKHARCHENKO, San Jose, CA (US); Keith STATTENFIELD, Santa Clara, CA (US); Kristin M. FORSTER, Los Altos Hills, CA (US)

(21) Appl. No.: 18/443,226

(22) Filed: Feb. 15, 2024

Related U.S. Application Data
(60) Provisional application No. 63/470,528, filed on Jun. 2, 2023.

(51) Int. Cl. G06F 9/451

(52) U.S. Cl. CPC G06F 9/452

(57) ABSTRACT

Some techniques are described herein for providing focus to a process of a computer system. In some embodiments, a system process can evaluate a request to provide focus to a user process using different sets of criteria (e.g., explicit donation criteria and/or implicit donation criteria) depending on whether another user process has indicated an intention to yield focus to the user process. In some embodiments, the system process can override a request to yield focus to a first process if the first process has previously indicated an intention to yield focus to a second process (e.g., via token chaining). In some embodiments, a user process can request to yield to a targeted other process and, in response, the system process can cause the targeted other process (or a different process via token chaining) to receive focus and perform an operation.

### CROSS-REFERENCE TO RELATED APPLICATIONS

The present application claims priority to U.S. Provisional Patent Application Ser. No. 63/470,528, entitled “TECHNIQUES FOR PROVIDING FOCUS” filed Jun. 2, 2023, which is hereby incorporated by reference in its entirety for all purposes.

### BACKGROUND

Computer systems are becoming increasingly complex. For example, a single computer system often has many different processes executing at the same time, including different applications that each have their own user interfaces. Managing focus of such user interfaces between these processes can be difficult. Accordingly, there is a need to improve techniques for providing focus to a process of a computer system.

### SUMMARY

Current techniques for providing focus are generally ineffective and/or inefficient. For example, some techniques result in a currently focused process of a computer system inadvertently yielding focus to a requesting process at a disruptive and/or inconvenient time and/or in a non-cooperative manner. Such yielding can allow the requesting process to cause their own user interface to be displayed over a user interface of the currently focused process. This disclosure provides more effective and/or efficient techniques for providing focus using examples of a system process providing focus to user processes executing on a computer system. It should be recognized that other types of computer system architectures can be used with techniques described herein. For example, any component (e.g., software and/or hardware) can provide focus to any other component of a computer system using techniques described herein. In addition, techniques optionally complement or replace other techniques for providing focus.

Some techniques are described herein for providing focus to a process of the computer system. For example, a system process can evaluate a request to provide focus to a user process using different sets of criteria (e.g., explicit donation criteria and/or implicit donation criteria) depending on whether another user process has indicated an intention to yield focus to the user process. For another example, the system process can override a request to yield focus to a first process if the first process has previously indicated an intention to yield focus to a second process (e.g., via token chaining). For another example, a user process can request to yield to a targeted other process and, in response, the system process can cause the targeted other process to receive focus and perform an operation.

In some embodiments, a method that is performed at a system process of a computer system is described. In some embodiments, the method comprises: receiving, from a first process of the computer system, a request to receive focus of the computer system, wherein the first process is different from a system process performing the method; and in response to receiving the request to receive focus: in accordance with a determination that a second process has identified the first process in a request to provide focus and in accordance with a determination that a first set of one or more criteria is satisfied, providing focus to the first process, wherein the second process is different from the first process and the system process; and in accordance with a determination that a third process has not identified the first process in a request to provide focus and in accordance with a determination that a second set of one or more criteria is satisfied, providing focus to the first process, wherein the third process is different from the first process and the system process.

In some embodiments, a non-transitory computer-readable storage medium storing one or more programs configured to be executed by one or more processors of a computer system is described. In some embodiments, the one or more programs includes instructions for: receiving, from a first process of the computer system, a request to receive focus of the computer system, wherein the first process is different from a system process performing the instructions; and in response to receiving the request to receive focus: in accordance with a determination that a second process has identified the first process in a request to provide focus and in accordance with a determination that a first set of one or more criteria is satisfied, providing focus to the first process, wherein the second process is different from the first process and the system process; and in accordance with a determination that a third process has not identified the first process in a request to provide focus and in accordance with a determination that a second set of one or more criteria is satisfied, providing focus to the first process, wherein the third process is different from the first process and the system process.

In some embodiments, a transitory computer-readable storage medium storing one or more programs configured to be executed by one or more processors of a computer system is described. In some embodiments, the one or more programs includes instructions for: receiving, from a first process of the computer system, a request to receive focus of the computer system, wherein the first process is different from a system process performing the instructions; and in response to receiving the request to receive focus: in accordance with a determination that a second process has identified the first process in a request to provide focus and in accordance with a determination that a first set of one or more criteria is satisfied, providing focus to the first process, wherein the second process is different from the first process and the system process; and in accordance with a determination that a third process has not identified the first process in a request to provide focus and in accordance with a determination that a second set of one or more criteria is satisfied, providing focus to the first process, wherein the third process is different from the first process and the system process.

In some embodiments, a computer system is described. In some embodiments, the computer system comprises one or more processors and memory storing one or more program configured to be executed by the one or more processors. In some embodiments, the one or more programs includes instructions for: receiving, from a first process of the computer system, a request to receive focus of the computer system, wherein the first process is different from a system process performing the instructions; and in response to receiving the request to receive focus: in accordance with a determination that a second process has identified the first process in a request to provide focus and in accordance with a determination that a first set of one or more criteria is satisfied, providing focus to the first process, wherein the second process is different from the first process and the system process; and in accordance with a determination that a third process has not identified the first process in a request to provide focus and in accordance with a determination that a second set of one or more criteria is satisfied, providing focus to the first process, wherein the third process is different from the first process and the system process.

In some embodiments, a computer system is described. In some embodiments, the computer system comprises means for performing each of the following steps: receiving, from a first process of the computer system, a request to receive focus of the computer system, wherein the first process is different from a system process performing the steps; and in response to receiving the request to receive focus: in accordance with a determination that a second process has identified the first process in a request to provide focus and in accordance with a determination that a first set of one or more criteria is satisfied, providing focus to the first process, wherein the second process is different from the first process and the system process; and in accordance with a determination that a third process has not identified the first process in a request to provide focus and in accordance with a determination that a second set of one or more criteria is satisfied, providing focus to the first process, wherein the third process is different from the first process and the system process.

In some embodiments, a computer program product is described. In some embodiments, the computer program product comprises one or more programs configured to be executed by one or more processors of a computer system. In some embodiments, the one or more programs include instructions for: receiving, from a first process of the computer system, a request to receive focus of the computer system, wherein the first process is different from a system process performing the instructions; and in response to receiving the request to receive focus: in accordance with a determination that a second process has identified the first process in a request to provide focus and in accordance with a determination that a first set of one or more criteria is satisfied, providing focus to the first process, wherein the second process is different from the first process and the system process; and in accordance with a determination that a third process has not identified the first process in a request to provide focus and in accordance with a determination that a second set of one or more criteria is satisfied, providing focus to the first process, wherein the third process is different from the first process and the system process.

In some embodiments, a method that is performed at a system process of a computer system is described. In some embodiments, the method comprises: receiving, from a first process of the computer system, a request to provide focus of the computer system to a second process different from the first process, wherein the first process is different from the system process, and wherein the second process is different from the system process; and in response to receiving the request to provide focus, in accordance with a determination that a first configuration setting corresponding to the second process indicates an intent to provide focus to a third process different from the second process, the first process, and the system process, and in accordance with a determination that a set of one or more criteria is satisfied, providing focus to the third process.

In some embodiments, a non-transitory computer-readable storage medium storing one or more programs configured to be executed by one or more processors of a computer system is described. In some embodiments, the one or more programs includes instructions for: receiving, from a first process of the computer system, a request to provide focus of the computer system to a second process different from the first process, wherein the first process is different from a system process performing the instructions, and wherein the second process is different from the system process; and in response to receiving the request to provide focus, in accordance with a determination that a first configuration setting corresponding to the second process indicates an intent to provide focus to a third process different from the second process, the first process, and the system process, and in accordance with a determination that a set of one or more criteria is satisfied, providing focus to the third process.

In some embodiments, a transitory computer-readable storage medium storing one or more programs configured to be executed by one or more processors of a computer system is described. In some embodiments, the one or more programs includes instructions for: receiving, from a first process of the computer system, a request to provide focus of the computer system to a second process different from the first process, wherein the first process is different from a system process performing the instructions, and wherein the second process is different from the system process; and in response to receiving the request to provide focus, in accordance with a determination that a first configuration setting corresponding to the second process indicates an intent to provide focus to a third process different from the second process, the first process, and the system process, and in accordance with a determination that a set of one or more criteria is satisfied, providing focus to the third process.

In some embodiments, a computer system is described. In some embodiments, the computer system comprises one or more processors and memory storing one or more program configured to be executed by the one or more processors. In some embodiments, the one or more programs includes instructions for: receiving, from a first process of the computer system, a request to provide focus of the computer system to a second process different from the first process, wherein the first process is different from a system process performing the instructions, and wherein the second process is different from the system process; and in response to receiving the request to provide focus, in accordance with a determination that a first configuration setting corresponding to the second process indicates an intent to provide focus to a third process different from the second process, the first process, and the system process, and in accordance with a determination that a set of one or more criteria is satisfied, providing focus to the third process.

In some embodiments, a computer system is described. In some embodiments, the computer system comprises means for performing each of the following steps: receiving, from a first process of the computer system, a request to provide focus of the computer system to a second process different from the first process, wherein the first process is different from a system process performing the steps, and wherein the second process is different from the system process; and in response to receiving the request to provide focus, in accordance with a determination that a first configuration setting corresponding to the second process indicates an intent to provide focus to a third process different from the second process, the first process, and the system process, and in accordance with a determination that a set of one or more criteria is satisfied, providing focus to the third process.

In some embodiments, a computer program product is described. In some embodiments, the computer program product comprises one or more programs configured to be executed by one or more processors of a computer system. In some embodiments, the one or more programs include instructions for: receiving, from a first process of the computer system, a request to provide focus of the computer system to a second process different from the first process, wherein the first process is different from a system process performing the instructions, and wherein the second process is different from the system process; and in response to receiving the request to provide focus, in accordance with a determination that a first configuration setting corresponding to the second process indicates an intent to provide focus to a third process different from the second process, the first process, and the system process, and in accordance with a determination that a set of one or more criteria is satisfied, providing focus to the third process.

In some embodiments, a method that is performed at a first process of a computer system is described. In some embodiments, the method comprises: while the first process has focus of the computer system, detecting that an event occurred; in response to detecting that the event occurred: sending, to a system process of the computer application, a request to provide focus to a second process of the computer system, wherein the request identifies the second process, wherein the first process is different from the system process, and wherein the second process is different from the first process and the system process; and causing, separate from sending the request, the second process to perform an operation.

In some embodiments, a non-transitory computer-readable storage medium storing one or more programs configured to be executed by one or more processors of a computer system is described. In some embodiments, the one or more programs includes instructions for: while a first process has focus of the computer system, detecting that an event occurred; in response to detecting that the event occurred: sending, to a system process of the computer application, a request to provide focus to a second process of the computer system, wherein the request identifies the second process, wherein the first process is different from the system process, and wherein the second process is different from the first process and the system process; and causing, separate from sending the request, the second process to perform an operation.

In some embodiments, a transitory computer-readable storage medium storing one or more programs configured to be executed by one or more processors of computer system is described. In some embodiments, the one or more programs includes instructions for: while a first process has focus of the computer system, detecting that an event occurred; in response to detecting that the event occurred: sending, to a system process of the computer application, a request to provide focus to a second process of the computer system, wherein the request identifies the second process, wherein the first process is different from the system process, and wherein the second process is different from the first process and the system process; and causing, separate from sending the request, the second process to perform an operation.

In some embodiments, a computer system is described. In some embodiments, the computer system comprises one or more processors and memory storing one or more program configured to be executed by the one or more processors. In some embodiments, the one or more programs includes instructions for: while a first process has focus of the computer system, detecting that an event occurred; in response to detecting that the event occurred: sending, to a system process of the computer application, a request to provide focus to a second process of the computer system, wherein the request identifies the second process, wherein the first process is different from the system process, and wherein the second process is different from the first process and the system process; and causing, separate from sending the request, the second process to perform an operation.

In some embodiments, a computer system is described. In some embodiments, the computer system comprises means for performing each of the following steps: while a first process has focus of the computer system, detecting that an event occurred; in response to detecting that the event occurred: sending, to a system process of the computer application, a request to provide focus to a second process of the computer system, wherein the request identifies the second process, wherein the first process is different from the system process, and wherein the second process is different from the first process and the system process; and causing, separate from sending the request, the second process to perform an operation.

In some embodiments, a computer program product is described. In some embodiments, the computer program product comprises one or more programs configured to be executed by one or more processors of a computer system. In some embodiments, the one or more programs include instructions for: while a first process has focus of the computer system, detecting that an event occurred; in response to detecting that the event occurred: sending, to a system process of the computer application, a request to provide focus to a second process of the computer system, wherein the request identifies the second process, wherein the first process is different from the system process, and wherein the second process is different from the first process and the system process; and causing, separate from sending the request, the second process to perform an operation.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described examples, reference should be made to the Detailed Description below, in conjunction with the following drawings in which like reference numerals refer to corresponding parts throughout the figures.

FIG. 1 is a block diagram illustrating a compute system in accordance with some embodiments.

FIG. 2 is a block diagram illustrating a device with interconnected subsystems in accordance with some embodiments.

FIG. 3A is a block diagram illustrating a software architecture of a computer system in accordance with some embodiments.

FIG. 3B is a block diagram illustrating a graphical user interface in accordance with some embodiments.

FIG. 4 is a flow diagram illustrating a process for determining whether to provide focus to an application process of a computer system in accordance with some embodiments.

FIG. 5 is a flow diagram illustrating a method for providing focus in accordance with some embodiments.

FIG. 6 is a flow diagram illustrating a method for providing focus in accordance with some embodiments.

FIG. 7 is a flow diagram illustrating a method for providing focus in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary examples.

Methods and/or processes described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a subsystem device could be termed a subsystem device, without departing from the scope of the various described examples. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

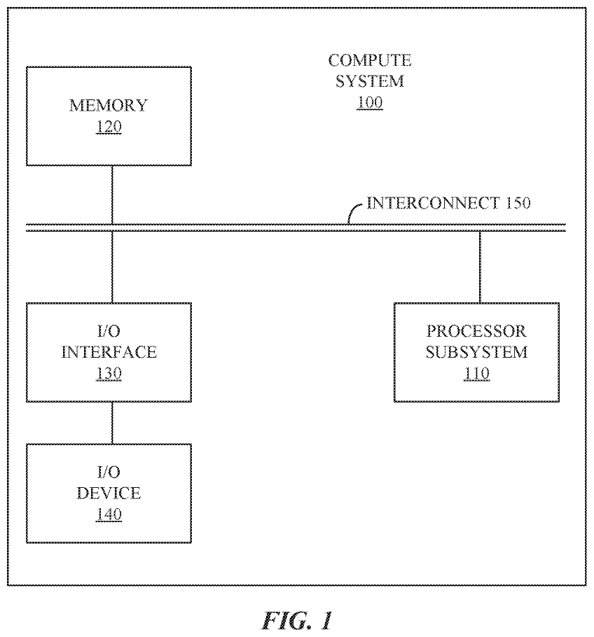

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

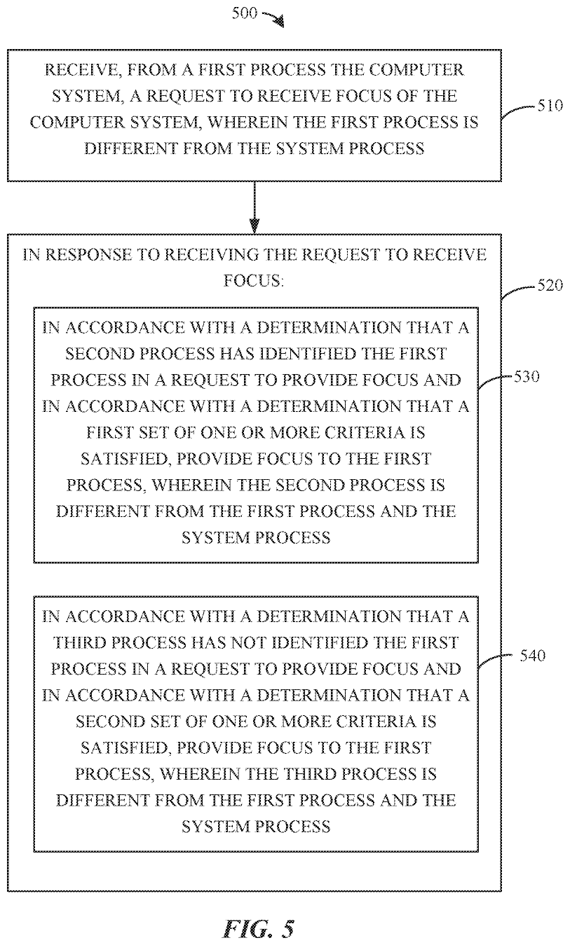

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 500, 600, and 700 (FIGS. 5, 6, and 7) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, display generation component (e.g., light, screen, projector, monitor, television, head mounted display), or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

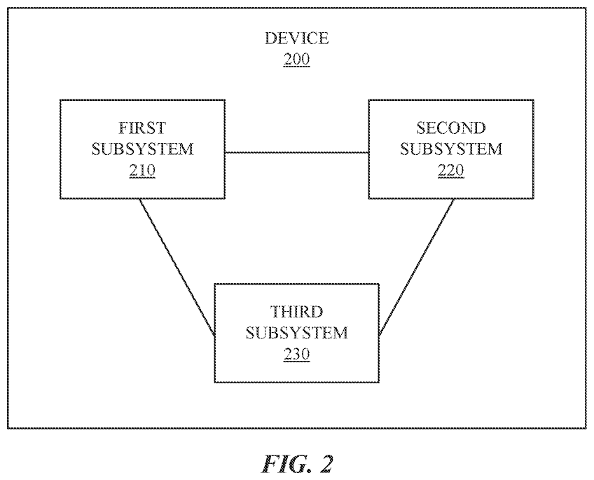

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some embodiments, some subsystems are not connected to other subsystems (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

As used herein, an “installed application” refers to a software application that has been downloaded onto a computer system (e.g., compute system 100 and/or device 200) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of a system/global internal state and/or an application internal state). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards techniques for providing focus. Such techniques are described in the context of a system process providing focus to user processes executing on a computer system. It should be recognized that other types of computer system architectures can be used with techniques described herein. For example, any component (e.g., software and/or hardware) can provide focus to any other component of a computer system using techniques described herein. In addition, techniques optionally complement or replace other techniques for providing focus.

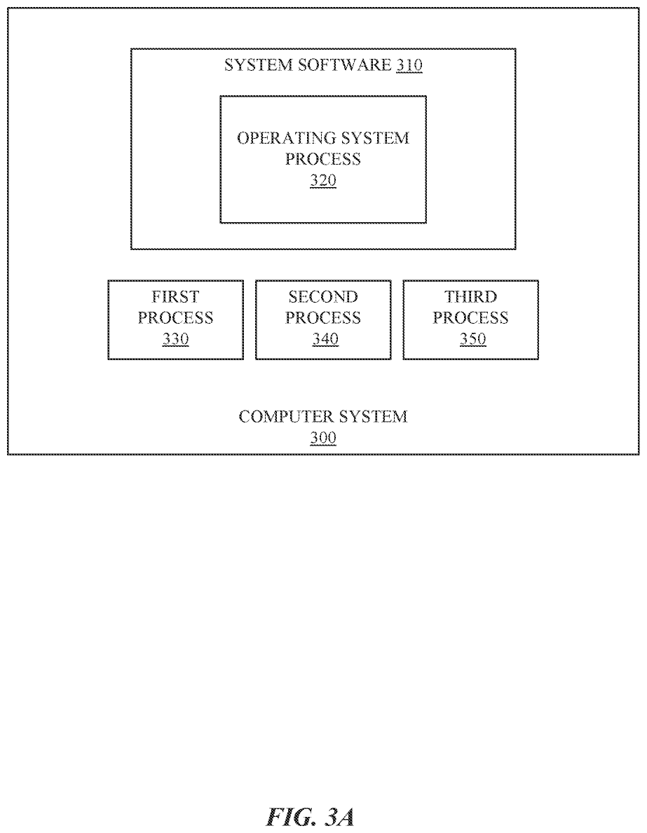

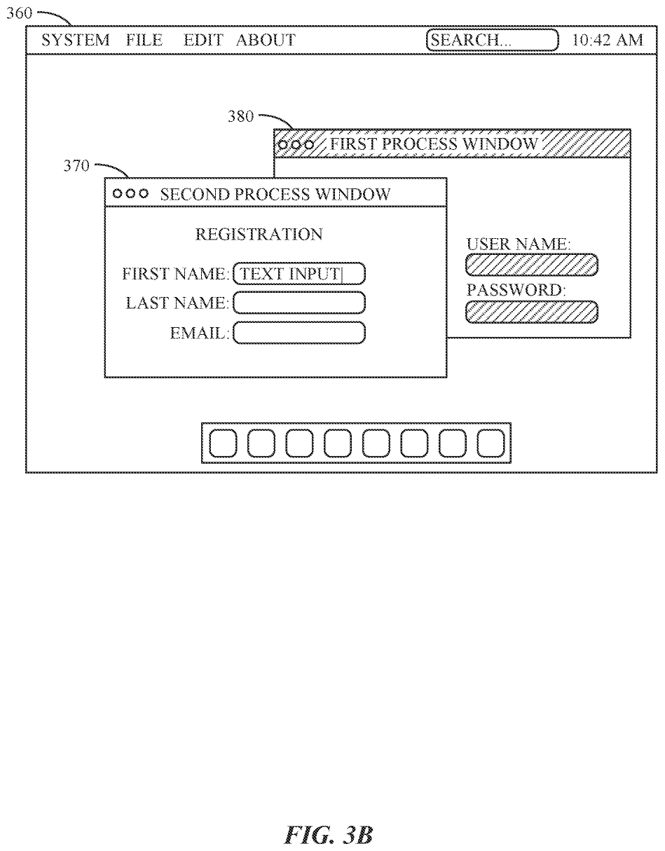

FIG. 3A is a block diagram illustrating an exemplary software architecture that includes logical blocks representing software and/or processes executing on an exemplary computer system 300. In some embodiments, computer system 300 is and/or includes one or more of the features described above with respect to compute system 100 and/or device 200. In this example, computer system 300 includes multiple processes that are configured to be executed on and/or by computer system 300. In some embodiments, a process is one or more of an application, a program, a routine, an agent, a daemon, a service, an applet, an executable, a set of one or more instructions stored in memory, a widget, and/or the like, that is being executed by (e.g., is actively running on) one or more processors of computer system 300. As illustrated in FIG. 3, computer system 300 includes system software 310, which represents software configured to run computer system 300 (e.g., managing interface with hardware of computer system 300, providing a platform for running application processes, and/or managing system resources). An example of system software is an operating system, which when installed on computer system 300 can cause one or more operating system processes to execute on computer system 300. As illustrated in FIG. 3A, system software 310 includes operating system process 320 (also referred to herein as “system process 320”). In some embodiments, computer system 300 includes a plurality of system processes. In some embodiments, system process 320 represents a plurality of system processes. For example, reference to one or more functions, operations, steps, instructions, and/or actions performed and/or caused to be performed by system process 320 should be interpreted as covering both being performed by a single system process referred to as system process 320 or multiple system processes collectively referred to system process 320.

As illustrated in FIG. 3A, computer system 300 also includes multiple processes, including first process 330 (e.g., representing a first application), second process 340 (e.g., representing a second application), and third process 350 (e.g., representing a third application). In some embodiments, a process is an application process representing a software application executing (e.g., running) on one or more processors of computer system 300. In some embodiments, a software application (also referred to as an “application”) is a program, a routine, an applet, an executable, a set of one or more instructions stored in memory, and/or a widget for performing one or more tasks that do not include managing the operation of computer system 300. For the discussion below, first process 330, second process 340, and third process 350 are application processes that correspond respectively to different respective applications. It should be recognized that other configurations are within scope of this disclosure, including multiple processes corresponding to the same application.

In the example illustrated in FIG. 3A, system process 320 is responsible for managing a focus setting of a graphical user interface that computer system 300 is causing to be displayed (e.g., via a display generation component). In some embodiments, system process 320 is a window management process of an operating system of computer system 300. In some embodiments, a focus setting represents selection of a process and/or associated user interface element (e.g., a window, a user interface object, a menu, a dialog box, an overlay, an icon, and/or a text entry field) of a graphical user interface that currently has focus. In some embodiments, changing focus includes changing the focus setting. In some embodiments, system process 320 also manages one of more of: which processes can have focus, under what conditions a process can have focus, requirements for providing focus to a process, requirements for transferring focus (e.g., taking from one process and providing to another process), one or more sets of one or more criteria for providing focus, procedures for providing focus, and/or characteristics (e.g., input and/or display) of having focus. Examples of focus with respect to a graphical user interface are described below with respect to FIG. 3B.

FIG. 3B illustrates an exemplary graphical user interface 360. Computer system 300 displays, via a display generation component in communication with computer system 300, graphical user interface 360. In this example, graphical user interface 360 is a user interface of an operating system, and includes multiple windows displayed overlaid on a desktop background, including second process window 370 and first process window 380. Second process window 370 corresponds to an application process (e.g., second process 340 of FIG. 3A) that currently has focus. In some embodiments, an element (e.g., user interface element) that has, and/or corresponds to an application process that has, focus is displayed on top of elements that do not have focus. For example, as illustrated in FIG. 3B, second process window 370 has focus and so is displayed as a frontmost window (e.g., displaying on top of other windows that do not have focus) (e.g., is overlaid on first process window 380 that does not have focus). In some embodiments, an element that has focus is configured to receive input (e.g., from an input device in communication with computer system 300). For example, as illustrated in FIG. 3B, second process window 370 has focus and so is configured to receive input as illustrated by text entry into computer system 300 appearing in the “First Name” text input field of second process window 370. As illustrated in FIG. 3B, first process window 380 includes a text entry field as well but does not receive text entry into its text input fields while it does not have focus—in FIG. 3B, the text input fields of first process window 380 are blank. In some embodiments, a process that has focus and as a result a window (e.g., or other user interface element) corresponding to the process is displayed as a frontmost window and/or a window corresponding to the process is configured to receive input (e.g., keyboard input, mouse input, and/or gesture input). In some embodiments, an element that does not have focus has a receded appearance that is different from a frontmost appearance. For example, first process window 380 does not have focus so it has a receded appearance that includes shading (illustrated as hatching in FIG. 3B) that darkens the appearance of the title bar at the top of the window and the text entry fields inside of the window. In some embodiments, an element that does have focus has a frontmost appearance that is different from a receded appearance. For example, second process window 370 has focus so it has a frontmost appearance that does not include shading that darkens the appearance of the title bar at the top of the window and the text entry fields inside of the window.

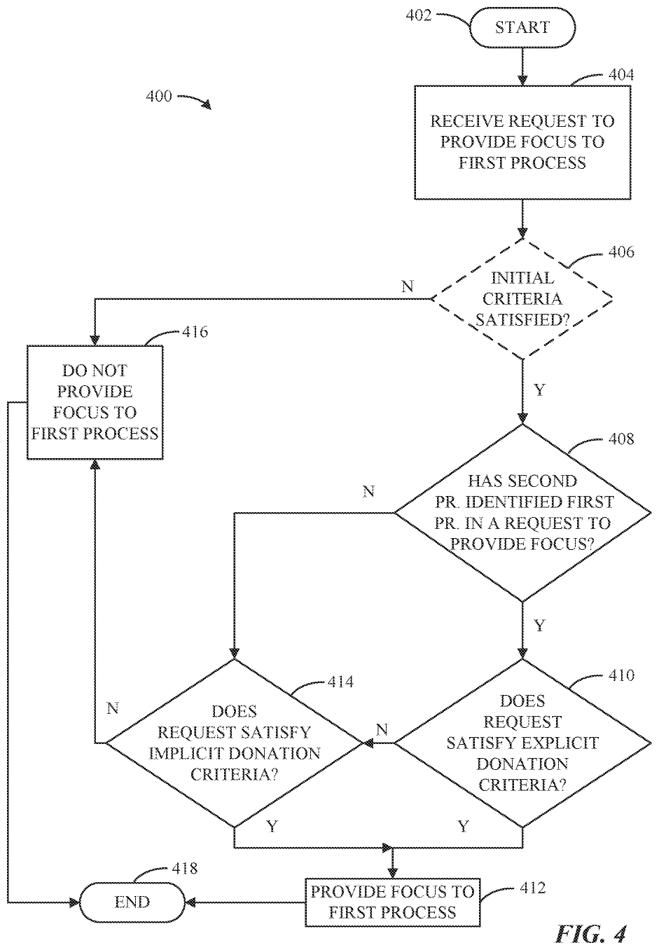

FIG. 4 illustrates a flowchart of a process (e.g., process 400) for determining whether to provide focus to an application process of a computer system, in accordance with some embodiments. In some embodiments, process 400 is performed by an electronic device such as compute system 100, device 200, and/or computer system 300. In some embodiments, process 400 is to be performed by one or more operating system processes (e.g., system process 320). In some embodiments, the one or more operating system processes (e.g., system process 320) include one or more of: an application user interface process, an application services process, a core services process, a core operating system process, and/or a kernel process. As one skilled in the art will appreciate, a computer system can include one or more system processes that perform operations for and/or on behalf of an operating system of the computer system. The responsibilities of (e.g., tasks and/or operations performed and/or managed by) a system process can be arbitrarily defined (e.g., due to legacy requirements, technical requirements, and/or design decisions), and therefore there can be any number of system processes in a set of one or more system processes on a computer system. The techniques described herein can be performed by one or more system processes. Description herein of one or more operations, techniques, steps, blocks, and/or actions being performed (and/or caused to be performed) by a “process” can likewise be performed by a plurality of processes and still be within the scope of this disclosure. The example illustrated in FIG. 4 will be described with respect to exemplary system process 320, first process 330, and second process 340 of FIG. 3A.

At block 402, process 400 starts (e.g., system process 320 begins executing). At block 404, system process 320 receives a request to provide focus to first process 330. In some embodiments, system process 320 receives the request to provide focus from an application process (e.g., from first process 330 or second process 340) and/or from a system process. In some embodiments, system process 320 receives the request via an application programming interface (API) (e.g., for making a request to provide focus, a request to yield focus, a request to receive focus, and/or a request for focus). For example, an application process can call the API in order to request focus be provided to itself and/or call the API in order to request focus be provided to another application process. In some embodiments, a request to provide focus to a particular process refers to any request that corresponds to a request that a system process provides (e.g., grants, assigns, selects for, and/or gives) focus to the particular process (including requests made by the particular process itself and/or requests made on behalf of the particular process by another process). In some embodiments, a request to yield focus is a request, from a process that has focus, to a system process requesting to “yield” (e.g., give up, hand over, and/or donate) focus to another process. In some embodiments, a request to receive focus and/or a request for focus refers to requests by a process to a system process requesting focus be given to the process (e.g., a request for itself). In some embodiments, system process 320 receives the requests to provide focus not via the API (e.g., not via a focus-related API, via a legacy API, and/or not via an API). In such embodiments, the requests can be handed via implicit donation (also referred to as “implicit yielding”), as described herein.

In some embodiments, system process 320 receives the request for focus from the requesting application process and performs (and/or causes one or more other processes to perform) one or more operations. In some embodiments, a respective process that creates (e.g., submits, transmits, and/or signs) a request for providing focus is referred to as a “requester.” In some embodiments, the request to provide focus to first process 330 is created by first process 330 (e.g., requesting to receive focus), so first process 330 is the requester. In some embodiments, the request for focus for first process 330 is created by a different process other than first process 330 (e.g., requesting to provide focus to another process). After receiving the request to provide focus to a first process, system process 320 proceeds to block 406.

At block 406, system process 320 optionally determines whether a set of one or more initial criteria is satisfied. For example, the set of one or more initial criteria can include criteria such as whether focus can currently be transferred between processes, whether the request is valid, and/or whether the requester and/or target process is eligible (e.g., eligible based on one or more characteristics such as: process type, environment (recovery OS or base OS), and/or current state). A target process is a process to which a request indicates focus should be given. In this example, the target is first process 330. In some embodiments, the set of one or more initial criteria includes other criteria, in addition to and/or in replacement of those listed here. In accordance with a determination that the set of one or more initial criteria is satisfied, system process 320 proceeds to block 408. In accordance with a determination that the set of one or more initial criteria is not satisfied, process 400 does not proceed to block 408 (e.g., proceeds instead to block 416 or block 418). In the example of FIG. 4, in accordance with a determination that the set of one or more initial criteria is not satisfied, system process 320 proceeds to block 416.

In some embodiments, system process 320 collects information about the request to provide focus to the first process. In some embodiments, the information about the request includes one or more of: a timestamp of an event that triggered the request to provide focus, a timestamp of the request, and/or an identity of the process that made the request. As used herein, “timestamp” refers to any measure that can be used to represent timing and/or an order, such as a time, a date, a relative positioning, an ordering, an increasing counter (e.g., a seed), and/or the like. In some embodiments, the information is used in one or more determinations of whether to provide focus, as will be discussed in more detail below. In some embodiments, in accordance with a determination that the information is not available, system process 320 performs a different process for providing focus (e.g., different than process 400 shown in FIG. 4) (e.g., falls back to a different process that does not rely on the information, such as a legacy and/or simplified process). In the example illustrated in FIG. 4, the determination of whether the information is available can be performed prior to and/or at block 404 (e.g., determine that a request is not valid if required information is missing, and thus that no valid request is received) and/or at block 406 (e.g., determine that the lack of the information causes the initial criteria to not be satisfied).

In some embodiments, the set of one or more initial criteria includes one or more determination of whether the request to provide focus is cooperative (e.g., whether the request to provide focus involves cooperation between two processes (e.g., a process yielding focus (also referred to as a “donor” of focus) and a process that will receive focus (also referred to as a “donee” of focus). In some embodiments, in accordance with a determination that the activation request is cooperative, a determination is made whether a donor is eligible to donate focus (e.g., if donor does not currently have focus (e.g., and/or if it is not an ancestor of a process that has focus), it is not eligible to donate focus that it does not have).

In some embodiments, a determination of whether the set of one or more initial criteria is satisfied includes one or more determination of whether an application (e.g., corresponding to a target process) is fully launched. For example, whether an application that corresponds to (e.g., is) first process 330 is launched, executing, and/or causing display of a user interface that has focus (e.g., as first process 330). In some embodiments, a determination of whether the set of one or more initial criteria is satisfied includes one or more determination of whether an application was terminated automatically (e.g., previously, such as within a predefined period time from when the determination of whether the set of one or more initial criteria is satisfied is made). For example, whether first process 330 was terminated automatically prior to the request. In some embodiments, a determination of whether the set of one or more initial criteria is satisfied includes one or more determinations of whether an application (e.g., corresponding to first process 330 for which focus is requested) was launched in a limited (e.g., throttled and/or isolated) state (e.g., with limited and/or reduced ability to interface with resources and/or other applications and/or processes) (e.g., for security and/or privacy purposes) (e.g., managed and/or enforced by one or more system process (e.g., 320)). In some embodiments, a determination of whether the set of one or more initial criteria is satisfied includes one or more determination of whether the request is pre-verified (e.g., includes and/or corresponds to an indication that the request is verified by one or more of a system process, an application process, and/or a trusted system framework) (e.g., if pre-verified then request is valid and/or passes an initial criterion). In some embodiments, a determination of whether the set of one or more initial criteria is satisfied includes one or more determinations of whether a process of the computer system is currently receiving text input (e.g., secure input, such as input of text in a password field). In some embodiments, in accordance with a determination that the computer system is currently receiving text input, the request to provide focus fails (e.g., in order to prevent focus being transferred to another process while sensitive data is being inputted). In some embodiments, a determination of whether the set of one or more initial criteria is satisfied includes one or more determinations of whether an application (e.g., corresponding to first process 330 for which focus is requested) is eligible to have focus (e.g., eligible to be the frontmost window) (e.g., if not eligible then the request fails). In some embodiments, a determination of whether the set of one or more initial criteria is satisfied includes one or more determination of whether a timestamp associated with the request (and/or effectively attributed to the request) meets one or more criteria with respect to one or more other timestamps (e.g., timestamp of last user request and/or launch of the application associated with first process 330). For example, if a timestamp of a last user event (e.g., an input such as a pointer movement or click event and/or input from a keyboard) indicates that the user has moved to a different application and/or typed elsewhere since the request to provide focus was received, the request to provide focus can be considered expired. It should be recognized that other forms of time besides a timestamp can be used in some embodiments. For example, a date and/or an increasing counter can be used in some embodiments.

In some embodiments, the system process evaluates the set of one or more initial criteria in a serial and/or cascading manner. For example, the computer system first evaluates whether a first initial criterion is satisfied and if satisfied moves on to evaluate a second initial criterion and/or allow the request (e.g., “Yes” at block 406), and if not satisfied denies the request (e.g., “No” at block 406) and/or proceeds to evaluate a third initial criterion (e.g., the same as or different from the second initial criterion), and so on. Evaluating criteria in a cascading manner can enable ordering the criteria in a manner of decreasing certainty and/or importance. It can also enable easily incorporating new criteria and/or reordering existing criteria, including being able to integrate any legacy requirements while implementing new ones.

Blocks 408, 410, and 414 represent operations related to using one or more sets of criteria to determine whether system process 320 will provide focus according to the request to provide focus. In this example, blocks 408 and 410 relate to operations for determining whether criteria related to explicit donation of focus are satisfied. In some embodiments, explicit donation of focus includes scenarios in which a donor has explicitly indicated (e.g., via a request and/or token) an intention to yield focus to another process. In this example, block 414 relates to operations for determining if criteria related to implicit donation of focus are satisfied. In some embodiments, implicit donation of focus includes scenarios in which a donor has not explicitly indicated intention to yield focus, but where one or more conditions (e.g., states, relationships, statuses, and/or inputs) exist that satisfy a set of one or more criteria (e.g., a set of one or more determinations of user intent) indicating that yielding focus can be performed. For example, the set of one or more criteria being satisfied is sufficient to establish and/or conclude an implicit intent to yield focus to a target process.

At block 408, system process 320 determines whether second process 340 has identified first process 330 in a request to provide focus to first process 330 (e.g., the same request received at block 404 or a different request). In some embodiments, the request is a request by second process 340 to yield focus to first process 330 (e.g., is the request received at block 404). In some embodiments, the request to provide the focus to the first process (e.g., received at block 404) does not include the request by second process 340 to yield focus. For example, the request to yield can be received at a time independent of (e.g., before and/or after) the request, and be stored in memory (e.g., as a token and/or other element of data) and evaluated by the operations of block 408. In accordance with a determination that second process 340 has identified first process 330 in a request to provide focus to first process 330 (“Yes” at block 408), system process 320 proceeds to block 410. In accordance with a determination that second process 340 has not identified first process 330 in a request to provide focus to first process 330 (“No” at block 408), system process 320 does not proceed to block 410 (e.g., proceeds instead to block 418 or another block different from 410). In the example of FIG. 4, in accordance with a “No” at block 408, system process 320 proceeds to block 414 to evaluate implicit donation criteria. Proceeding from block 408 when criteria is not satisfied to block 414 is an example of cascading evaluation of criteria—e.g., where a set of one or more criteria is not satisfied, the request can still be successful (e.g., reach block 412) via satisfaction of one or more other sets of one or more criteria.

In some embodiments, determining whether the second process has identified first process 330 in a request to provide focus to first process 330 includes determining whether a token exists and/or is valid. In some embodiments, the token indicates intention to provide and/or yield focus to another process (e.g., identified in and/or corresponding to the token). For example, a token can be created by second process 340 and indicate an intention to yield focus to first process 330. In some embodiments, the token is created by second process 340 by calling an API (e.g., causing a system process, in response to receiving a request via the API, to create and/or store the token). In some embodiments, other data is used instead of a token, where such other data can be used to indicate intention to provide and/or yield focus to another process, such as a configuration, a setting, a file, a pointer, a link, and/or a data entry. In some embodiments, in accordance with a determination that a valid token exists (e.g., “Yes” at block 408), system process 320 evaluates the request using a set of one or more explicit donation criteria (e.g., at block 410). In some embodiments, in accordance with a determination that a valid token does not exist (e.g., “No” at block 408), system process 320 evaluates the request using a set of one or more implicit donation criteria (e.g., at block 414). In some embodiments, a token is determined to not be valid if it has expired (e.g., due to an expiration time being exceeded and/or due to having been previously used to yield focus a maximum number of allowed times (e.g., token was already used to yield focus to a donee by a donor)). In some embodiments, the token is determined to be valid if the token is a most recent token (e.g., is not superseded by a newer token from same process) and is targeted to the target process identified at block 404 (e.g., first process 330) (e.g., check if the process that wants to be frontmost is targeted by this token). In some embodiments, a token is determined to not be valid (e.g., expired) if a timestamp of a last user event is more recent than a timestamp of the request to provide focus. For example, the system process checks the timestamp of the most recent application launching (e.g., activating and/or beginning execution) and/or the timestamp of a most recently dispatched input event (e.g., a mouse click), and if the request is earlier than either one of those, the token is considered expired (e.g., and is invalidated by one or more system processes).

At block 410, system process 320 determines whether a set of one or more explicit donation criteria is satisfied. For example, the set of one or more explicit donation criteria can include criteria such as whether focus can currently be transferred between processes, whether the request is valid, and/or whether the requester and/or target process is eligible. Other criteria can be used, in addition to and/or in replacement of, those listed here. In accordance with a determination that the set of one or more explicit donation criteria is satisfied, system process 320 proceeds to block 412. In accordance with a determination that the set of one or more explicit donation criteria is not satisfied, system process 320 does not proceed to block 412 (e.g., proceeds instead to block 414, block 416, or block 418). In the example of FIG. 4, in accordance with a determination that the set of one or more explicit donation criteria is not satisfied, system process 320 proceeds to block 414 to evaluate implicit donation criteria.

In some embodiments, the set of one or more explicit donation criteria includes a criterion that is satisfied in accordance with a determination that the token is eligible to be redeemed (e.g., by the target process for which focus is requested, the donee). In some embodiments, the set of one or more explicit donation criteria includes a criterion that is satisfied in accordance with a determination that a timestamp of the request is more recent than a timestamp of a last input event (e.g., of a received user input, such as a click and/or a keyboard key press). In some embodiments, the set of one or more explicit donation criteria includes a criterion that is satisfied in accordance with a determination that a target process identified by the token is valid and/or resolvable (e.g., an identifier specified in the token is valid and/or corresponds to a process that can be identified based on the identifier). In some embodiments, the set of one or more explicit donation criteria includes a criterion that is satisfied in accordance with the requester (e.g., the creator of the token and/or the requester that submitted the request to provide focus received at block 404) is privileged (e.g., eligible to provide, receive, and/or yield focus while not having focus (e.g., is not frontmost)). In some embodiments, a privileged process (e.g., requester) is a trusted system client, such as a first-party application. In some embodiments, a privileged process does not have to be eligible following other criteria in order to be eligible. In some embodiments, the set of one or more explicit donation criteria includes a criterion that is satisfied in accordance with a determination that the requester is a frontmost process (e.g., a process corresponding to a frontmost window (e.g., second process window 370 of FIG. 3B) in a graphical user interface (e.g., 360) of the operating system). In some embodiments, a frontmost process owns a key (e.g., active) window (e.g., a window that is drawn with an emphasized/active appearance). In some embodiments, a key window is (or, alternatively, is not) in front of all other windows. For example, a key window may be covered by one or more system overlays that are in front of all other windows but that are not an active/key/focused window or application (e.g., focus is maintained by the frontmost process even though the frontmost process does not correspond to the frontmost window). In some embodiments, the set of one or more explicit donation criteria includes a criterion that is satisfied in accordance with a determination that one of the requester's ancestors (e.g., a process that owns the requester, that includes the requester, that caused the requester to launch, and/or that previously yielded to the requester) is a frontmost process. In some embodiments, system process 320 evaluates the set of one or more explicit donation criteria in a serial and/or cascading manner. For example, system process 320 first evaluates whether a first explicit donation criterion is satisfied (e.g., whether an identifier of a target process is valid) and, if satisfied, moves on to evaluate a second explicit criterion and/or to allow the request (e.g., “Yes” at block 410) and, if not satisfied, denies the request (e.g., “No” at block 410) and/or proceeds to evaluate a third explicit donation criterion (e.g., the same as or different from the second explicit donation criterion), and so on.

As illustrated in FIG. 4, system process 320 proceeds to block 412 in response to a determination that some set of one or more criteria have been satisfied, such as explicit donation criteria and/or implicit donation criteria. At block 412, system process 320 provides focus to first process 330 (e.g., transfers focus from second process 340 to first process 330). For example, referring to the example in FIG. 3B, system process 320 providing focus to first process 330 can cause first process window 380 (which corresponds to first process 330) to become frontmost and overlap second process window 370 (which corresponds to second process 340). Additionally, or alternatively, system process 320 providing focus to first process 330 can cause first process 330 to be the focus of input-that is, be the primary, first, and/or only application process that receives input received by computer system 300 via one or more input devices (e.g., keystrokes of a keyboard and/or image data from a camera), instead of (e.g., to the exclusion of) second process 340. For example, if focus of input is provided to first process 330, then first process window 380 will receive subsequent input of text entry into one of its text entry fields, while second process window 370 will not receive such input. In some embodiments, providing focus includes providing a target process with both frontmost status (e.g., making an associated window frontmost) and focus of input.

As noted above, in accordance with a determination that the second process has not identified the first process in a request to provide focus (e.g., “No” at block 408) or in accordance with a determination that the set of one or more explicit donation criteria is not satisfied (e.g., “No” at block 410), system process 320 proceeds to block 414. For example, if a token is not available and/or if a token is not valid, system process 320 can forgo proceeding to block 410 (e.g., to evaluate explicit donation criteria) and instead proceed directly to block 414 (e.g., to evaluate implicit donation criteria). In some embodiments, implicit donation criteria include a set of one or more criteria that are used to determine whether user intent and/or a state of computer system 300 permits providing focus according to the request to provide focus (e.g., received at block 404). If a determination is made, based at least in part on evaluation of the set of one or more criteria, that user intent and/or the state of the computer system (e.g., a state of one or more process running thereon) does not preclude providing focus to the first process, focus can be provided to the first process. Reference herein to determining, measuring, and/or inferring (and/or similar concepts) user intent refers to an intention expressed via user activity that an action should and/or can occur (e.g., operation performed and/or result obtained). For example, user activity can be used to determine a user intent that a new window be given focus. Reference herein to determining, measuring, and/or inferring (and/or similar concepts) user intent can also refer to an intention that an action not occur. For example, user activity can be used to determine a user intent that focus not be taken away from a window currently in focus (e.g., that user is interacting with).

At block 414, system process 320 determines whether a set of one or more implicit donation criteria is satisfied. For example, the set of one or more implicit donation criteria can include criteria such as whether focus can currently be transferred between processes, whether the request is valid, and/or whether the requester and/or target process is eligible. Other criteria can be used, in addition to and/or in replacement of, those listed here. In accordance with a determination that the set of one or more implicit donation criteria is satisfied, system process 320 proceeds to block 412. In accordance with a determination that the set of one or more implicit donation criteria is not satisfied, system process 320 does not proceed to block 412 (e.g., proceeds instead to block 416 or 418). In the example of FIG. 4, in accordance with a determination that the set of one or more explicit donation criteria is not satisfied, system process 320 proceeds to block 416.

In some embodiments, the set of one or more implicit donation criteria includes a criterion that is satisfied in accordance with a determination that the requester and the target process are not the same process (e.g., a separate and distinct process requests focus for the first process via an API request to a system process). In some embodiments, the set of one or more implicit donation criteria includes a criterion that is satisfied in accordance with a determination that the requester and/or target process is frontable (e.g., able to have frontmost status and be a frontmost process corresponding to a frontmost window). For example, if the requester is not frontable, the criterion is not satisfied. In some embodiments, the set of one or more implicit donation criteria includes a criterion that is satisfied in accordance with a determination that the requester is currently the frontmost process. For example, if the requester is frontable, the process proceeds to check if the requester is the frontmost process-if not, the criterion is not satisfied and/or in some embodiments implicit donation fails (e.g., the requester cannot donate a focus that it does not have, so its request to make another process frontmost fails). In some embodiments, the set of one or more implicit donation criteria includes a criterion that is satisfied in accordance with a determination that one of the requester's ancestors is a frontmost process. In some embodiments, system process 320 evaluates the set of one or more implicit donation criteria in a serial and/or cascading manner. For example, system process 320 first evaluates whether a first implicit donation criterion is satisfied (e.g., whether is requester is frontable) and, if satisfied, moves on to evaluate a second implicit criterion and/or allow the request (e.g., “Yes” at block 414) and, if not satisfied, denies the request (e.g., “No” at block 414) and/or proceeds to evaluate a third implicit donation criterion (e.g., the same as or different from the second implicit donation criterion), and so on.

In some embodiments, the set of one or more implicit donation criteria includes a criterion that is satisfied in accordance with a determination that the requester and the target are the same process (e.g., first process 330 is requesting focus for itself). In some embodiments, the set of one or more implicit donation criteria includes a criterion that is satisfied in accordance with a determination that one of the requester's ancestors is a frontmost process. For example, when the target process is the requester, system process 320 uses a different set and/or subset of one or more criteria than when the target process is different from the requester. In some embodiments, the set of one or more implicit donation criteria includes one or more criterion related to: characteristics of the target process's windows, characteristics of the target process's launching (e.g., activation and/or execution), and/or characteristics of one or more inputs and/or input devices (e.g., mouse cursor location within graphical user interface of the operating system).

In some embodiments, the set of one or more explicit donation criteria is different from the set of one or more implicit donation criteria. In some embodiments, the set of one or more explicit donation criteria includes at least one criterion from the set of one or more implicit donation criteria. In some embodiments, the set of one or more implicit donation criteria includes at least one criterion from the set of one or more explicit donation criteria. In some embodiments, the set of one or more explicit donation criteria is the same as the set of one or more implicit donation criteria. In some embodiments, the set of one or more implicit donation criteria includes the set of one or more explicit donation criteria. In some embodiments, the set of one or more explicit donation criteria includes the set of one or more implicit donation criteria. In some embodiments, the set of one or more explicit donation criteria and/or the set of one or more implicit donation criteria depend on a state of the computer system when receiving the request to provide focus (e.g., status of input and/or status of windows).

In some embodiments, focus can be explicitly donated (e.g., via a request to provide focus and/or a token). In some embodiments, focus can be considered implicitly donated (e.g., no explicit request to donate focus and/or a token is made, but evaluation of criteria establishes that focus should be donated). In some embodiments, the focus donation operations are opaque to a requester process and/or target process. For example, an application (e.g., donee and/or donor) involved in donation operation is not provided access, by a system process, to information about a token and/or a request to provide focus associated with the operation. Rather, a donor process can use an API to submit a request to yield focus and specify a target process to which it would like to yield focus. This request to yield focus is passed to one or more system processes. In some embodiments, a target process does not have access to information regarding tokens that have been donated that identify the target process as a target for yielding focus to. For example, with respect to the target process, the opaque nature of the token means that the target process does not have a way to check and see if it has been donated to and/or even whether a relevant donation token exists. Rather, the target process can merely request activation (e.g., by submitting a request for focus via an API).

In some embodiments, a process can donate a token (e.g., create a token and/or cause a token to be created for yielding focus to a target process), but system process 320 will consider the token valid under certain conditions (e.g., specified by one or more system configurations and/or settings of computer system 300). For example, a valid request, a valid token, and/or a satisfaction of the explicit donation criteria can still result in focus not being donated to the target process due to one or more conditions not being satisfied. For example, user input with certain characteristics can override an earlier request to donate focus (e.g., so as not to interfere with activity of the user whose input now indicates a different intent than when the donation request was made).

In some embodiments, donation of focus (e.g., of a token) and activation (e.g., providing focus) are distinct processes. For example, when token chaining occurs the system process 320 can receive a request to donate a token from a donor and note that a donee process is eligible to receive focus, but will not immediately transfer focus state until a subsequent request (e.g., request for focus) is received from one of the parties. In some embodiments, donation of focus and activation are performed in response to the same request.

In some embodiments, token donation can be chained (also referred to herein as “token chaining”) (e.g., transferred and/or forwarded). For example, first process 330 of FIG. 3 can submit a request (e.g., to system process 320) to yield focus to second process 340. Second process 340 can establish (e.g., create and/or cause to be created) (e.g., before and/or after the request submitting by first process 330) a valid token that yields focus to third process 350 of FIG. 3 (e.g., a token stored by the computer system that causes system process 320 to yield focus to whenever second process 340 is granted focus). Based on the token representing donation of focus from the second process 340 to third process 350, focus provided to the second process 340 should end up at third process 350. In some embodiments, system process 320 performs token chaining and provides focus from first process 330 to third process 350 in response to the request to yield focus to second process 340. In some embodiments, performing token chaining includes skipping over second process 340. For example, second process 340 is not called, activated, and/or provided focus at any point, rather focus changes from first process 330 directly to third process 350 (e.g., the token and/or focus is rerouted based on the token chaining). In some embodiments, a timestamp associated with a request and/or token is updated to correctly attribute the time of the first request that initiated the token chaining (e.g., timestamp of yield request from first process 330 to second process 340 is used for the evaluation of token validity for yielding from second process 340 to third process 350). In some embodiments, second process 340 is unaware it was provided focus and/or that token chaining occurred (e.g., token chaining caused focus to bypass second process 340). In some embodiments, second process 340 is yielded (e.g., receives) focus and immediately yields focus to third process 350 (e.g., using the techniques described above). An example use of token chaining includes an authentication process being yielded to, which automatically yields focus to a biometric activation process. In this example, biometric authentication can be the preferred manner of authentication to unlock a device, so an authentication process that is called can desire to yield first to the biometric activation process so that biometric data can be gathered before the authentication process receives focus.

At block 416, system process 320 does not provide focus to first process 330. For example, this occurs if both explicit donation criteria and implicit donation criteria are not satisfied. At block 418, system process 320 ends process 400.

FIG. 5 is a flow diagram illustrating a method (e.g., method 500) for providing focus in accordance with some embodiments. Some operations in method 500 are, optionally, combined, the orders of some operations are, optionally, changed, and some operations are, optionally, omitted.

As described below, method 500 provides an intuitive way for providing focus. Method 500 reduces the cognitive burden on a user for providing focus, thereby creating a more efficient human-machine interface. For battery-operated computing devices, enabling a user to provide focus faster and more efficiently conserves power and increases the time between battery charges.

In some embodiments, method 500 is performed at a system process (e.g., 320) (e.g., an operating system process) of a computer system (e.g., 300).

At 510, the system process receives, from a first process (e.g., 330) (e.g., an application, a user application, a non-system process, and/or a user process) of the computer system (e.g., 300), a request to receive focus (e.g., of display and/or input operations) of the computer system, wherein the first process is different from the system process (e.g., 320).

At 520, in response to receiving the request to receive focus, in accordance with a determination (at 530) that a second process (e.g., 340 and/or 350) has identified the first process (e.g., 330) in a request to provide focus and in accordance with a determination that a first set of one or more criteria (e.g., explicit donation criteria) is satisfied, the system process provides (e.g., establishes, gives, and/or sets) focus to the first process (e.g., explicit donation) (e.g., the system process causes the first process to have focus), wherein the second process is different from the first process and the system process (e.g., 320).

At 520, in response to receiving the request to receive focus, in accordance with a determination (at 540) that a third process (e.g., 340 and/or 350) has not identified the first process (e.g., 330) in a request to provide focus and in accordance with a determination that a second set of one or more criteria (e.g., implicit donation criteria) is satisfied, the system process provides focus to the first process (e.g., implicit donation), wherein the third process is different from the first process and the system process (e.g., 320). In some embodiments, the second process is the third process. In some embodiments, the third process is different from the second process. In some embodiments, the first set of one or more criteria includes a first set of one or more attention criteria. In some embodiments, the second set of one or more criteria includes the first set of attention criteria. In some embodiments, the second set of one or more criteria includes a second set of attention criteria different from the first set of attention criteria. In some embodiments, the first set of one or more criteria includes a first set of state criteria. In some embodiments, the second set of one or more criteria includes the first set of state criteria. In some embodiments, the second set of one or more criteria includes a second set of state criteria different from the first set of state criteria. In some embodiments, in accordance with a determination (1) that the second process has identified the first process in the request to provide focus, (2) that the first set of one or more criteria (e.g., explicit donation criteria) is not satisfied, and (3) that the second set of one or more criteria (e.g., implicit donation criteria) is satisfied, the system process provides focus to the first process (e.g., implicit donation occurs even after explicit donation criteria not met).

In some embodiments, the first set of one or more criteria is different from the second set of one or more criteria (e.g., are not the same set of criteria, one set includes at least one criterion not included in the other set, and/or both sets include a common set (e.g., a same set, a base set, and/or a shared set) of criteria in addition to other respective criteria). In some embodiments, the first set of one or more criteria includes one or more explicit focus donation criteria. In some embodiments, the second set of one or more criteria includes one or more implicit focus donation criteria. In some embodiments, in accordance with a determination that the first set of one or more criteria is not satisfied, the computer system (e.g., 300) (e.g., the system process (e.g., 320)) causes performance of a determination of whether the second set of one or more criteria is satisfied.

In some embodiments, the second set of one or more criteria includes the first set of one or more criteria (e.g., the first set of one or more criteria is a subset (e.g., includes some but not all) of the second set of one or more criteria and/or the first set and the second set of one or more criteria are the same).

In some embodiments, the first set of one or more criteria, the second set of one or more criteria, or a combination thereof includes: a set of one or more criteria that is satisfied in accordance with a determination that the computer system (e.g., 300) is in a particular state when the request to receive focus is received by the system process (e.g., 320). In some embodiments, the particular state includes that the computer system is not currently receiving secure text input (e.g., a password, personal information, payment information, and/or sensitive information). In some embodiments, the particular state includes that the first process of the computer system is permitted to receive focus (e.g., is a focus-eligible process and/or is not a non-focus-eligible process). In some embodiments, the particular state is that the focus is available (e.g., to be donated to the first process). In some embodiments, the particular state is that the second process is eligible to donate (e.g., transfer, provide, and/or give) focus to the first process. In some embodiments, the particular state includes that one or more windows on a user interface of the computer system are in a respective state that does not preclude (e.g., due to configurations, settings, algorithms, and/or dependencies that establish conditions, criteria, and/or requirements for) transferring focus from one process to another (e.g., providing focus to the first process). In some embodiments, the particular state includes that one or more indications of user intent (e.g., actions and/or behaviors represented by input at an input device (e.g., mouse, touch-sensitive surface, and/or keyboard) that corresponds to an input indicator (e.g., cursor, pointer, and/or gaze location)) on a user interface of the computer system are in a respective state that does not preclude transferring focus. In some embodiments, a respective state that does not preclude transferring focus includes an indication of user intent representing that a user has not performed one or more inputs that are configured to interrupt transfer of focus (e.g., actions that, performed in conjunction with (e.g., before, while, and or after) the request for focus is received that indicate focus should not be transferred (e.g., user manually selects a different process and/or window that does not correspond to the first process, the second process, and/or the third process)).

In some embodiments, providing focus to the first process (e.g., 330) includes: causing display, via a display generation component in communication with (e.g., of) the computer system (e.g., 300), of a user interface (e.g., first process window 380) corresponding to the first process (e.g., 330) to overlay at least a portion of another user interface (e.g., second process window 370) (e.g., a user interface not corresponding to the first process (e.g., corresponding to a process that does not have focus)) different from the user interface corresponding to the first process. In some embodiments, the user interface corresponding to the first process is not allowed to overlay another user interface when the first process is not provided focus. In some embodiments, providing focus to the first process includes causing input, detected via one or more input devices in communication with (e.g., part of and/or connected to) the computer system, to be provided to the first process instead of a different process (e.g., 340 and/or 350) (e.g., the second process and/or the third process).

In some embodiments, the first set of one or more criteria includes a criterion that is satisfied in accordance with a determination that the second process (e.g., 340 and/or 350) has focus when (e.g., in conjunction with and/or at the time of) the request to receive focus is received by the system process (e.g., 320).

In some embodiments, in response to receiving the request to receive focus and in accordance with a determination that the second process (e.g., 340 and/or 350) has identified the first process (e.g., 330) in a request to provide focus and that the first set of one or more criteria (e.g., explicit donation criteria) is not satisfied, the system process forgoes providing focus to the first process (e.g., the system process (e.g., 320) does not cause the first process to have focus).

In some embodiments, in response to receiving the request to receive focus and in accordance with a determination that the third process (e.g., 340 and/or 350) has not identified the first process (e.g., 330) in the request to provide focus and that the second set of one or more criteria (e.g., implicit donation criteria) is not satisfied, the system process forgoes providing focus to the first process (e.g., the system process (e.g., 320) does not cause the first process to have focus).

Note that details of the processes described above with respect to method 500 (e.g., FIG. 5) are also applicable in an analogous manner to other methods described herein. For example, method 600 and/or 700 optionally includes one or more of the characteristics of the various methods described above with reference to method 500. For example, a request to provide focus to a process can cause a first and/or a second set of one or more criteria to be evaluated. For brevity, these details are not repeated below.

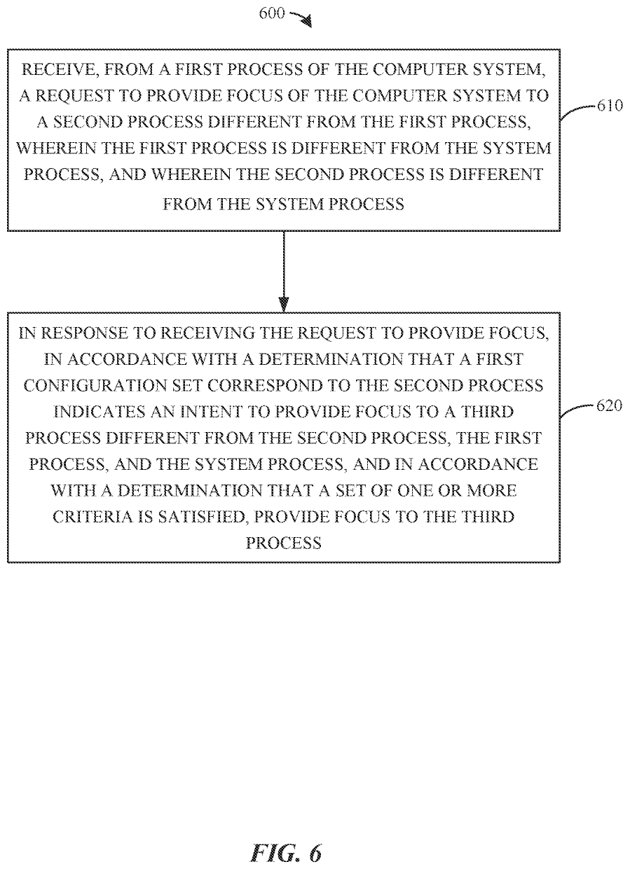

FIG. 6 is a flow diagram illustrating a method (e.g., method 600) for providing focus in accordance with some embodiments. Some operations in method 600 are, optionally, combined, the orders of some operations are, optionally, changed, and some operations are, optionally, omitted.

As described below, method 600 provides an intuitive way for providing focus. Method 600 reduces the cognitive burden on a user for providing focus, thereby creating a more efficient human-machine interface. For battery-operated computing devices, enabling a user to provide focus faster and more efficiently conserves power and increases the time between battery charges.

In some embodiments, method 600 is performed at a system process (e.g., 320) (e.g., as described above with respect to method 500) of a computer system (e.g., 300).

At 610, the system process receives, from a first process (e.g., 330) of the computer system (e.g., 300), a request to provide (e.g., yield, forfeit, and/or give) focus (e.g., as described above with respect to method 500) of the computer system to a second process (e.g., 340) different from the first process, wherein the first process is different from the system process (e.g., 320), and wherein the second process is different from the system process (e.g., 320). In some embodiments, the request to provide focus is received while the first process has focus of the computer system.

At 620, in response to receiving the request to provide focus, in accordance with a determination that a first configuration setting (e.g., a token, an established setting, and/or a received setting) corresponding to (e.g., associated with, received from, established by, established for, and/or provided by) the second process (e.g., 340) indicates an intent (e.g., a request and/or an instruction) to provide focus to a third process (e.g., 350) (e.g., when the second process is designated to be provided focus) different from the second process, the first process (e.g., 330), and the system process (e.g., 320), and in accordance with a determination that a set of one or more criteria (e.g., override criteria, yield criteria, and/or criteria defined in the configuration setting) is satisfied, the system process (e.g., 320) provides focus to the third process system process (e.g., instead of the second process) (e.g., and, in some embodiments, the system process forgoes providing focus to the second process) (e.g., the system process overrides providing focus to the second process and, in some embodiments, provides focus to the third process). In some embodiments, in response to receiving the request to provide focus, in accordance with a determination that the first configuration setting indicates an intent (e.g., a request and/or an instruction) to provide focus to the third process, and in accordance with a determination that the set of one or more criteria is satisfied, the system process forgoes providing focus to the second process. In some embodiments, in response to receiving the request to provide focus, in accordance with a determination that the first configuration setting indicates an intent to provide focus to the third process, and in accordance with a determination that the set of one or more criteria is not satisfied, the system process forgoes providing focus to the third process. In some embodiments, in response to receiving the request to provide focus, in accordance with a determination that the first configuration setting indicates an intent to provide focus to the third process, and in accordance with a determination that the set of one or more criteria is not satisfied, the system process provides focus to the second process. In some embodiments, in response to receiving the request to provide focus to the second process, in accordance with a determination that a configuration setting corresponding to the second process does not indicate an intent to provide focus to the third process, another set of one or more criteria different from the set of one or more criteria is used in a determination of whether to provide focus to a process other than the second process (e.g., to the third process).

In some embodiments, a set of one or more criteria to reroute focus (e.g., override providing focus to the second process 340) (e.g., to perform token chaining) includes one or more additional criteria to what is specified by the first configuration setting (e.g., additional criteria must be satisfied even if token is valid).

In some embodiments, the second process (e.g., 340) is not running at time of token chaining (e.g., at time that focus is rerouted) (e.g., a token exists that was previously explicitly donated). In some embodiments, the third process (e.g., 350) is not running at time of token chaining (e.g., at time that focus is rerouted).

In some embodiments, the second process (e.g., 340) sometimes does not yield focus to the third process (e.g., 350) (e.g., token is not always valid and/or used for yielding to third process).

In some embodiments, providing focus includes displaying a user interface (e.g., second process window 370) (e.g., of a respective process that has focus) at least partially in front of another user interface (e.g., of a different process) and/or providing input (e.g., keystrokes) detected by the device to a process (e.g., that has focus) in favor of another (e.g., different process).

In some embodiments, a different respective process is yielded to in different circumstance based on different configuration settings (e.g., depending on circumstances, second process 340 can automatically yield to different respective processes, as defined by one or more configuration settings).

In some embodiments, second process (e.g., 340) and third process (e.g., 350) are (e.g., are part of and/or processes of) different applications. In some embodiments, second process (e.g., 340) and first process (e.g., 330) are (e.g., are part of and/or processes of) different applications.

Note that details of the processes described above with respect to method 600 (e.g., FIG. 6) are also applicable in an analogous manner to other methods described herein. For example, method 500 and/or 700 optionally includes one or more of the characteristics of the various methods described above with reference to method 600. For example, a request to provide focus to a process can cause a first and/or a second set of one or more criteria to be evaluated. For brevity, these details are not repeated below.

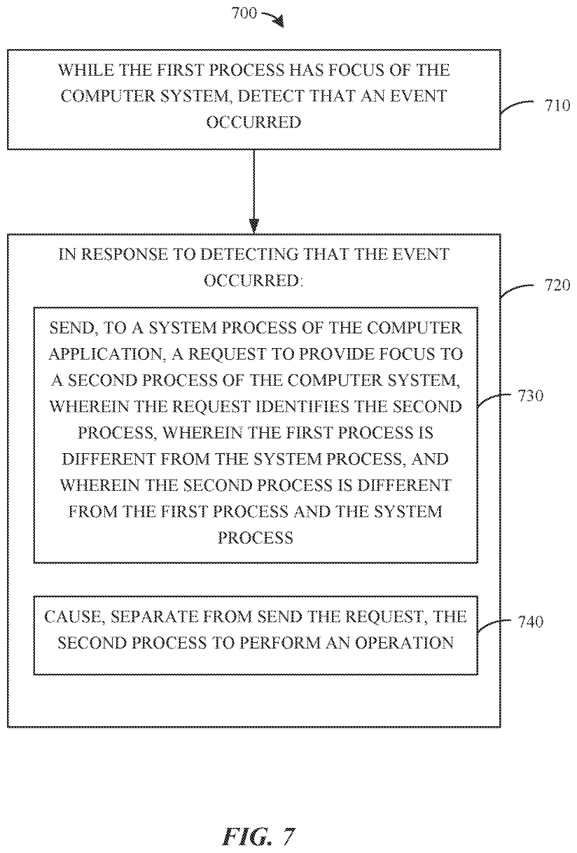

FIG. 7 is a flow diagram illustrating a method (e.g., method 700) for providing focus in accordance with some embodiments. Some operations in method 700 are, optionally, combined, the orders of some operations are, optionally, changed, and some operations are, optionally, omitted.

As described below, method 700 provides an intuitive way for providing focus. Method 700 reduces the cognitive burden on a user for providing focus, thereby creating a more efficient human-machine interface. For battery-operated computing devices, enabling a user to provide focus faster and more efficiently conserves power and increases the time between battery charges.

In some embodiments, method 700 is performed at a first process (e.g., 330) (e.g., an application process) of a computer system (e.g., 300).

At 702, while the first process (e.g., 330) has focus (e.g., as described above with respect to method 500) of the computer system (e.g., 300), the first process detects that an event occurred (e.g., that requires user input being received by another application, such as payment, checkout, and/or authentication).

At 720, in response to detecting that the event occurred, the first process (e.g., 330) sends (at 730), to a system process (e.g., 320) of the computer system, a request to provide focus (e.g., as described above with respect to method 500) to a second process (e.g., 340) of the computer system, wherein the request identifies the second process, wherein the first process is different from the system process, and wherein the second process is different from the first process and the system process.

At 720, in response to detecting that the event occurred, the first process (e.g., 330) causes (at 740), separate from sending the request, the second process (e.g., 340) to perform an operation (e.g., perform an operation for and/or as instructed by the first process). In some embodiments, causing the second process to perform the operation includes sending one or more instructions to the second process. In some embodiments, causing the second process to perform the operation includes sending data to the second process. In some embodiments, subsequent to causing the second process to perform the operation, the first process receives a result corresponding to performance of the operation.

In some embodiments, the first process (e.g., 330) detects that the event occurred while the third process (e.g., 350) is provided focus (e.g., the third process donated focus to the first process). In some embodiments, detecting that the event includes receiving a request to perform an operation from the third process.

In some embodiments, the first process (e.g., 330) detects that the event occurred while the first process is provided focus (e.g., detecting the event includes detecting user input with respect to a user interface of the first process).

In some embodiments, the second process (e.g., 340) is executing in the background (e.g., is not frontmost and/or does not have focus) when the event is detected, and causing the second process to perform an operation includes sending a request to the second process to execute in the foreground (e.g., as the frontmost window).

In some embodiments, the second process (e.g., 340) is not executing in the background (e.g., is not executing and/or running) when the event is detected, and the causing the second process to perform an operation includes sending a request to the second process to initiate execution of the second process.

In some embodiments, after causing second process (e.g., 340) to perform the operation, the first process (e.g., 330) receives a message indicating that the second process performed the operation and, in response to receiving the message, displays a user interface. In some embodiments, before displaying the user interface, the first process sends, to the system process (e.g., 320), a request to execute in the foreground (e.g., first process requests focus)

Note that details of the processes described above with respect to method 700 (e.g., FIG. 7) are also applicable in an analogous manner to the methods described herein. For example, method 500 and/or 600 optionally includes one or more of the characteristics of the various methods described above with reference to method 700. For example, a request to provide focus to a process can cause a first and/or a second set of one or more criteria to be evaluated. For brevity, these details are not repeated below.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how a device behaves during user operation. The present disclosure contemplates that in some instances, this gathered data can include information regarding user behavior and/or intent (e.g., patterns of user inputs).

The present disclosure recognizes that the use of such personal information data, in the present technology, can be used to the benefit of users. For example, the personal information data can be used to change how a device behaves during user operation. Accordingly, use of such personal information data enables better user interactions and operation of the computer system. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates examples in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, behavior of the computer system can be based on non-personal information (e.g., generalized data and/or non-personalized configurations applicable to users).

What is claimed is:

1. A method, comprising:
at a system process of a computer system:
receiving, from a first process of the computer system, a request to receive focus of the computer system, wherein the first process is different from the system process; and
in response to receiving the request to receive focus:
in accordance with a determination that a second process has identified the first process in a request to provide focus and in accordance with a determination that a first set of one or more criteria is satisfied, providing focus to the first process, wherein the second process is different from the first process and the system process; and
in accordance with a determination that a third process has not identified the first process in a request to provide focus and in accordance with a determination that a second set of one or more criteria is satisfied, providing focus to the first process, wherein the third process is different from the first process and the system process.

2. The method of claim 1, wherein the first set of one or more criteria is different from the second set of one or more criteria.

3. The method of claim 2, wherein the second set of one or more criteria includes the first set of one or more criteria.

4. The method of claim 1, wherein the first set of one or more criteria, the second set of one or more criteria, or a combination thereof includes:
a set of one or more criteria that is satisfied in accordance with a determination that the computer system is in a particular state when the request to receive focus is received by the system process.

5. The method of claim 1, wherein providing focus to the first process includes:
causing display, via a display generation component in communication with the computer system, of a user interface corresponding to the first process to overlay at least a portion of another user interface different from the user interface corresponding to the first process; or
causing input, detected via one or more input devices in communication with the computer system, to be provided to the first process instead of a different process.

6. The method of claim 1, wherein the first set of one or more criteria includes a criterion that is satisfied in accordance with a determination that the second process has focus when the request to receive focus is received by the system process.

7. The method of claim 1, further comprising:
in response to receiving the request to receive focus and in accordance with a determination that the second process has identified the first process in a request to provide focus and that the first set of one or more criteria is not satisfied, forgoing providing focus to the first process.

8. The method of claim 1, further comprising:
in response to receiving the request to receive focus and in accordance with a determination that the third process has not identified the first process in the request to provide focus and that the second set of one or more criteria is not satisfied, forgoing providing focus to the first process.

9. A non-transitory computer-readable storage medium storing one or more programs configured to be executed by one or more processors of a computer system, the one or more programs including instructions performed by a system process of the computer system for:
receiving, from a first process of the computer system, a request to receive focus of the computer system, wherein the first process is different from the system process; and
in response to receiving the request to receive focus:
in accordance with a determination that a second process has identified the first process in a request to provide focus and in accordance with a determination that a first set of one or more criteria is satisfied, providing focus to the first process, wherein the second process is different from the first process and the system process; and
in accordance with a determination that a third process has not identified the first process in a request to provide focus and in accordance with a determination that a second set of one or more criteria is satisfied, providing focus to the first process, wherein the third process is different from the first process and the system process.

10. A computer system, comprising:
one or more processors; and
memory storing one or more programs configured to be executed by the one or more processors, the one or more programs including instructions performed by a system process of the computer system for:
receiving, from a first process of the computer system, a request to receive focus of the computer system, wherein the first process is different from the system process; and
in response to receiving the request to receive focus:
in accordance with a determination that a second process has identified the first process in a request to provide focus and in accordance with a determination that a first set of one or more criteria is satisfied, providing focus to the first process, wherein the second process is different from the first process and the system process; and
in accordance with a determination that a third process has not identified the first process in a request to provide focus and in accordance with a determination that a second set of one or more criteria is satisfied, providing focus to the first process, wherein the third process is different from the first process and the system process.
